(19) United States
(12) Patent Application Publication
(10) Pub. No.: US 2003/0009417 A1
(43) Pub. Date: Jan. 9, 2003

(54) Volume-dependent price negotiation method and system

(76) Inventor: Troy Pappas, Mt. Laurel, NJ (US)

Correspondence Address: PEPPER HAMILTON LLP, One Mellon Center, 50th Floor, 500 Grant Street, Pittsburgh, PA, 15219, US

(21) Appl. No.: 10/191,836

(22) Filed: Jul. 9, 2002

Related U.S. Application Data
(60) Provisional application No. 60/303,872, filed on Jul. 9, 2001.

(51) Int. Cl. G06F 17/60

(52) U.S. Cl. 705/37

(57) ABSTRACT

A computer-implemented method and system for negotiating a purchase price for goods and/or services is capable of performing volume-dependent negotiations, which enables instantaneous and real time negotiations. The system prompts a customer for a bid comprising an identification of a good or service to be purchased, a quantity, and a desired price, compares the bid to a database of seller's information to determine if the price and quantity in the bid correspond to seller acceptable prices and quantities, and presents a response to the user.

### CLAIM OF PRIORITY

This application claims priority to the co-pending U.S. Provisional Patent Application entitled “Volume-Dependent Price Negotiation Method and System,” filed Jul. 9, 2001, having a serial No. of 60/308,872, which is incorporated herein by reference in its entirety.

### FIELD OF THE INVENTION

This system relates generally to methods and systems for negotiating the purchase price of goods and/or services. More particularly, the present invention relates to a method and system for negotiating a purchase price that is capable of performing volume-dependent negotiation.

### BACKGROUND OF THE INVENTION

Numerous electronic commerce sites have arisen on the Internet's World Wide Web in many forms. With the large number of electronic commerce websites that are available to consumers, it has become more important to provide both buyers and sellers with unique features that provide for easier and more effective transactions. One feature which most e-commerce sites have lacked is the ability to facilitate interactive negotiation of price between buyers and sellers. Typical e-commerce sites merely list a product or service and identify a price that is associated with the product or service. The potential buyer must either select the product at the listed price or go elsewhere to seek a better price.

One method that has been used to overcome this limitation is electronic mail. Buyers and sellers can communicate via electronic mail, with a buyer submitting a proposal and the seller responding with either an acceptance or a counterproposal. However, such a negotiation process is time consuming, as it depends on the responsiveness of the buyer and seller and even on whether the buyer and seller are on line at the same time. Thus, the time lag eliminates the advantage of speed that is speed and ease of use that are desired by users of e-commerce sites.

If a method and system were available that enabled instantaneous, real time, volume-dependent price negotiations, the universe of electronic commerce could be greatly expanded to apply to goods and services for which negotiation is appropriate. Because the system would have the potential of reducing the closing and commitment cycle of business transactions, both time and money could be saved.

The present invention is directed to solving one or more of the problems listed above.

### SUMMARY OF THE INVENTION

A preferred embodiment of the present invention provides a computer implemented method for dynamic negotiation of selling prices. The method includes the steps of (1) receiving a bid, preferably where the bid comprises an identification of a good or service to be purchased, a quantity, and a price; (2) accessing a database of seller's information, where the seller's information includes things to be sold, quantities, and volume-dependent acceptable prices that relate to the quantities and things to be sold; (3) comparing the bid to the seller's information; and (4) presenting a response to the user.

Optionally, the bid and/or the seller's information may include at least one seller-defined variable that affects the price. Also, the database may include at least one good or service to be sold, and the volume-dependent prices may determining step determines that the price included with the bid is equal to or greater than the acceptable price included in the database, the response included in the presenting step may include a response of acceptance to the bid. Alternatively, if the determining step determines that the price included with the bid is less than an acceptable price included in the database, the response preferably comprises inviting the user to renegotiate. Optionally, the method may also compare the bid to other bids in order to accept a predetermined number of high bids. A high bid may correspond to a single item, or a “high” bid may be a function of both price and quantity.

As additional options, the method may include the additional step of, before the presenting step, determining whether the user's bid comprises a modification to a previous bid submitted by the same user within a predetermined time period. Further, the response provided in the presenting step may include at least one of a streaming video and streaming audio presentation. Additionally, the presenting step may be performed via a communication network.

The method may be implemented by a system that includes a computing device having a processor, memory, and data input interface. The computer is connected to a network, and the memory includes the database of seller's information.

### BRIEF DESCRIPTION OF THE DRAWINGS

FIG. 1 is a block diagram that illustrates negotiation steps that may be followed in accordance with a preferred embodiment of the present invention.

FIG. 2 is a block diagram illustrating additional steps that may be followed in accordance with a preferred embodiment of the present invention.

FIG. 3 is an illustration of a representative computer that may be used with the present inventive method and system.

FIG. 4 is an internal block diagram of the representative computer of FIG. 3.

### DETAILED DESCRIPTION OF THE INVENTION

The present invention provides an interactive, dynamic bidding and pricing method and system that is scalable and can be used in any industry for the sale of any product or service. In accordance with a preferred embodiment of the present invention, a computer is equipped with a processor and a memory and is connected to a communications network, such as a local area network (LAN), a wide area network (WAN), an intranet, the Internet or another global communications network, or another communications medium such as a television distribution network or telephone distribution network. Optionally, the computer is a stand-alone computer with a display and an input device. The computer memory stores computer program instructions that instruct the computer to prompt the user as the user walks through a preferred embodiment of the negotiations process. The memory also includes a seller's information database containing the goods and/or services offered by the seller and the prices which the seller is willing to accept for various quantities of the goods and/or services. The seller's information database may be contained in the same memory containing the program instructions, or the seller's information may be in a database maintained on a separate memory within the computer, or on a separate computer that is connected to the computer either by direct connection or through a communications medium.

Optionally, the method and system may also provide auction-related functions and/or fixed (static) pricing, thereby offering the use of a wide range of pricing options.

The seller's information database contains volume-dependent pricing information. For example, the database may contain data that indicates that for a sale of a low quantity of a specified good or service, the seller will accept only a higher per-unit price. However, if the sale is for a high quantity of the good and/or service, the seller may be willing to accept a lower per-unit price.

As a more specific example, a seller that is selling pencils may provide data for the database indicating that if a buyer desires to buy between one and five pencils, the lowest price that the seller is willing to accept for each pencil is $.20 per pencil. However, if the buyer is willing to buy a greater quantity, such as between 50 and 100 pencils, the seller may be willing to accept a price as low as $.10 per pencil. Higher quantities may be associated with even lower prices, such as a price of $.05 per pencil for quantities greater than 1,000 in a single purchase. The goods, prices, and quantities listed above are only intended to serve as examples, and any good/service, price, and quantity may be used.

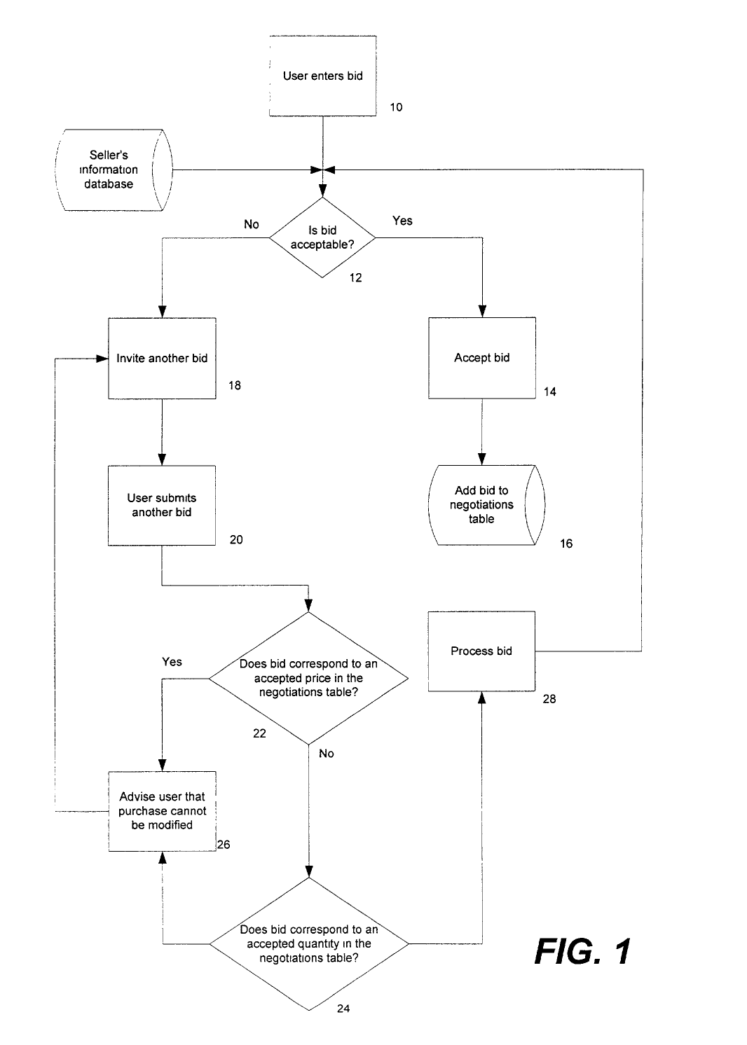

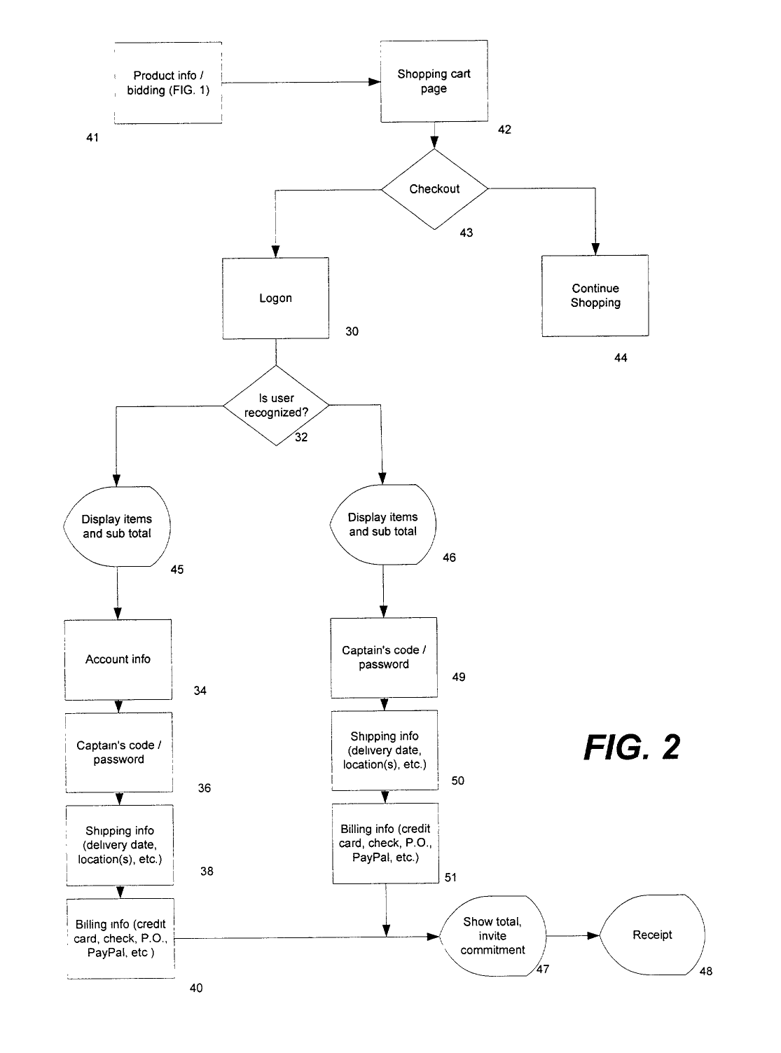

In a preferred embodiment, the program instructions instruct the computer to prompt the user to perform the negotiation in accordance with steps such as those illustrated in FIG. 1. Referring to FIG. 1, the user begins the negotiation by selecting a good or service and a quantity and offering a price which the buyer is willing to pay for the quantity of good or service (step 10). The system then compares the quantity and price to those contained in the seller's database for the good or service (step 12). If the buyer's offering price is equal to or greater than the price which the seller is willing to accept for the specified quantity, the bid is accepted (step 14) and preferably added to the user's shopping cart (step 42 in FIG. 2). Optionally, the quantity, price, and good or service that is accepted may also be added to a negotiation table (step 16) that is maintained in a computer memory, which may be in a location that is separate from that of the shopping cart.

If, in the comparing step (step 12), the bid is lower than the price which the seller is willing to accept at the specified quantity, the system will prompt the user to try again (step 18). The user then has the opportunity to renegotiate (step 20) by selecting another quantity and/or specifying another price.

Optionally, after the user has entered a first bid, subsequent bids may be reviewed against the negotiations table to see if the user is trying to renegotiate an already-accepted bid. For example, as described above, if a user offers to purchase fifty pencils at a cost of $.10 per pencil and the bid is accepted, the accepted bid may be added to a negotiations table (step 16). For subsequent lower-priced bids, such as a bid of fifty pencils for $.09 per pencil, the system may check the negotiations table (step 22), and reject the bid (step 26) because the user has already offered a higher price for the specified quantity. In addition, the system may also check to see if the user is trying to purchase a lower quantity at a previously accepted price (step 24). If the system finds that the user has already submitted an offer that was accepted, the system will notify the user that it cannot change to a lower quantity at the agreed upon price (step 26). If the user did not previously submit an accepted offer, the system may then allow the user to renegotiate a quantity (step 28) and accept the bid (step 14) if the subsequent offer is successful.

As additional options, the system may include time-out options corresponding to users and/or bids. For example, referring to FIG. 1, when the system prompts the user to enter another bid (step 18), the prompt may be retracted if the bid is not entered (step 20) within a predetermined time period. In addition, the negotiations table may be time-dependent, and successful negotiations may optionally be removed from the negotiations table after a period of time, such as thirty minutes or one hour or one day.

By including a database of seller goods and/or services, along with prices that are volume-dependent, the system provides for real time, and in many cases immediate, responses to buyer offers. The real time negotiation simulates the interaction of a sales person and buyer, thus offering the potential buyer with the experience of a “live” sales interaction.

In accordance with an optional embodiment of the present invention, a streaming media component, such as a streaming video component, may be included to enhance the user's experience. For example, prompts to the user, such as invitations to submit an offer, acceptances of an offer, and/or rejections of an offer, may be transmitted to the user's terminal by a streaming media method, such as streaming video, to be displayed on the user's web browser, television, interactive television, or other display device using conventional software such as Windows Media Player or RealPlayer, to provide the user with a more “real” experience. Optionally, the system can be self-contained on a single PC, laptop, or handheld computer, with all information contained in the computer's memory and the display of the computer providing the user with the simulated sales experience. Such an embodiment can allow the system to be used in a stand-alone kiosk, such as one that may be found in a shopping center, airport, or other location.

The availability of a seller's database that includes prices that are dependent upon volume allows for simultaneous business-to-business and business-to-consumer transactions using a single method and system. For example, manufacturers may want to sell to both wholesale and retail customers without providing two separate systems and/or price lists. Accordingly, a retail consumer, who may seek a lower quantity, will be provided with a higher per-unit acceptance price, while large volume consumers, such as wholesale customers, may be provided lower per-unit prices. Optionally, additional variables may be included in the database to affect the price, such as the user's geographic location, billing method (such as checks, credit card, or commercial payment systems such as Pay Pal), or other variables.

The system may also include auction capability, so that users can bid on a good or service or quantities of goods or services. Winning bidders can optionally include any bid that exceeds a predetermined threshold, the highest bid, a set number of highest bids, or the winning bid(s) may be a function of both price and quantity.

Optionally, the system may contain security provisions such as those illustrated on FIG. 2. Referring to FIG. 2, which illustrates an exemplary overall shopping process that may be used when the present inventive negotiation system has been completed, or optionally before the negotiations begin, a user may be prompted to enter logon information (step 30). The system then determines, based on the logon information, whether the user is a recognized user (step 32). If the user is not a recognized user, the user may be prompted to enter account information and/or establish an account (step 34), to enter a code such as a password, promotional code, or other code (step 36), and to enter other optional information such as shipping information and billing information (step 40). If, in the identification step (step 32), the system determines that the user is a recognized user, the entry of account information (step 34) may not be required.

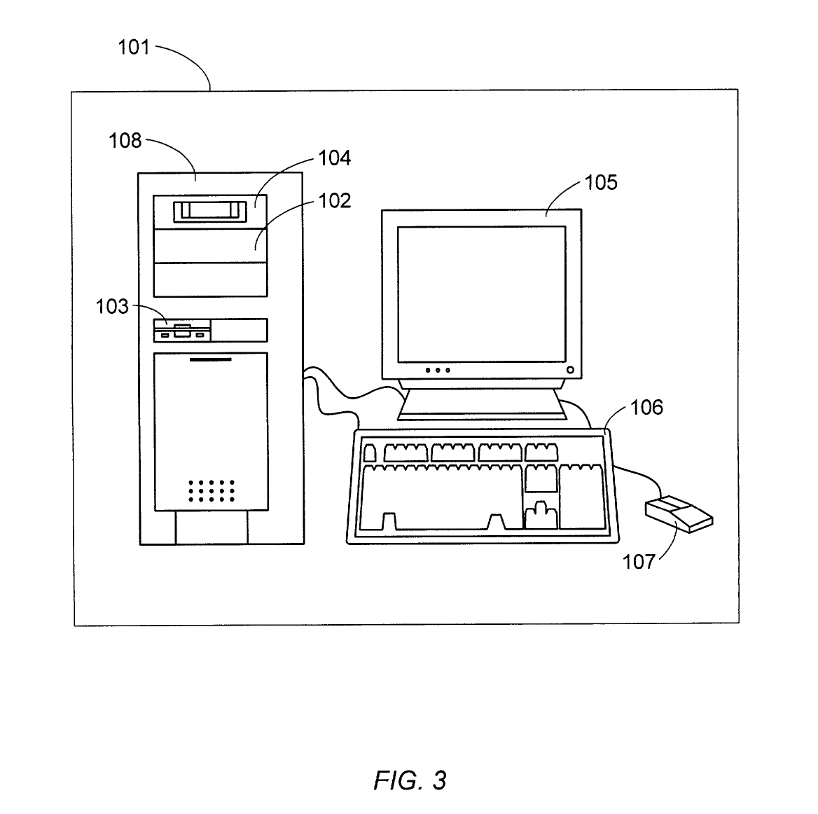

FIG. 3 illustrates an exemplary computer of a type suitable for carrying out and/or comprising the system of the invention. Viewed externally in FIG. 3, a computer system designated by reference numeral 101 has a central processing unit located within a housing 108 and disk drives 103 and 104. Disk drives 103 and 104 are merely symbolic of a number of disk drives which might be accommodated by the computer system. Typically these would include a hard disk drive and optionally one or more floppy disk drives such as 103 and/or one or more CD-ROMs, CD-Rs, CD-RWs or digital video disk (DVD) devices indicated by slot 104. The number and types of drives typically varies with different computer configurations. Disk drives 103 and 104 are in fact options, and they may be omitted from the computer system used in connection with the processes described herein. Additionally, the computer system utilized for implementing the present invention may be a stand-alone computer having communications capability, a computer connected to a network or able to communicate via a network, a handheld computing device, or any other form of computing device capable of carrying out equivalent operations.

The computer also has or is connected to or delivers signals to a display 105 upon which graphical, video and/or alphanumeric information is displayed. The display may be any device capable of presenting visual images, such as a television screen, a computer monitor, a projection device, a handheld or other microelectronic device having video, display capabilities, or even a device such as a headset or helmet worn by the user to present visual images to the user's eyes. The computer may also have or be connected to other means of obtaining signals to be processed. Such means of obtaining these signals may include any device capable of receiving images and image streams, such as video input and graphics cards, digital signal processing units, appropriately configured network connections, or any other microelectronic device having such input capabilities.

An optional keyboard 106 and a directing device 107 such as a remote control, mouse, joystick, touch pad, track ball, steering wheel, remote control or any other type of pointing or directing device may be provided as input devices to interface with the central processing unit.

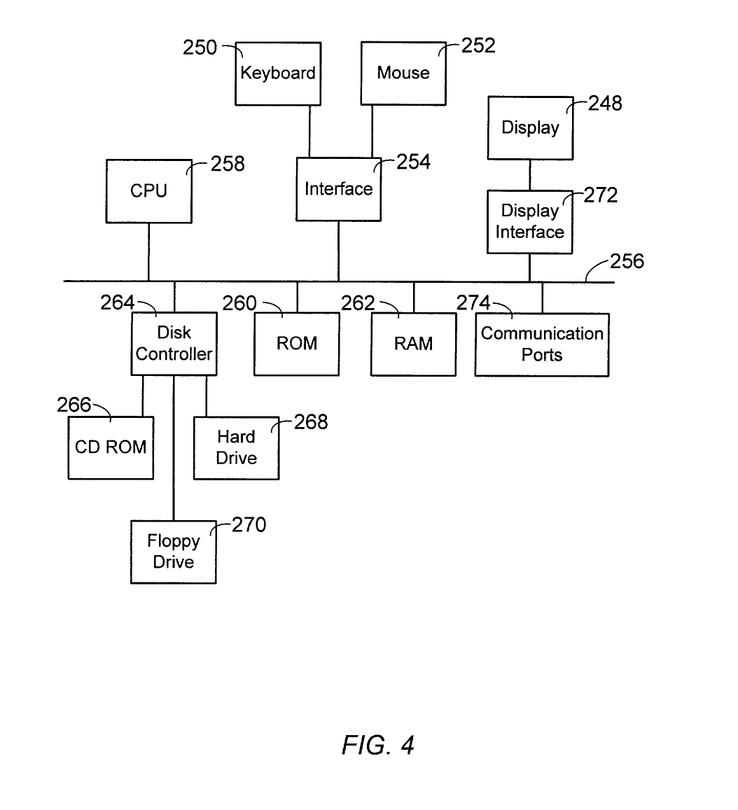

FIG. 4 illustrates a block diagram of the internal hardware of the computer of FIG. 3. A bus 256 serves as the main information highway interconnecting the other components of the computer. CPU 258 is the central processing unit of the system, performing calculations and logic operations required to execute a program. Read only memory (ROM) 260 and random access memory (RAM) 262 constitute the main memory of the computer.

A disk controller 264 interfaces one or more disk drives to the system bus 256. These disk drives may be external or internal floppy disk drives such as 270, external or internal CD-ROM, CD-R, CD-RW or DVD drives such as 266, or external or internal hard drives 268. As indicated previously, these various disk drives and disk controllers are optional devices.

Program instructions may be stored in the ROM 260 and/or the RAM 262. Optionally, program instructions may be stored on a computer readable carrier such as a floppy disk or a digital disk or other recording medium, a communications signal, or a carrier wave.

Returning to FIG. 4, a display interface 272 permits information from the bus 256 to be displayed on the display 248 in audio, graphic or alphanumeric format. Communication with external devices may optionally occur using various communication ports such as 274.

In addition to the standard components of the computer, the computer also includes an interface 254 which allows for data input through the keyboard 250 or other input device and/or the directional or pointing device 252 such as a remote control, pointer, mouse or joystick.

It is to be understood that the invention is not limited in its application to the details of construction and to the arrangements of the components set forth herein or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

The invention claimed is:

1. A computer-implemented method for volume-dependent negotiation of a sale of goods and/or services, comprising the steps of:
receiving a bid from a customer;
accessing a database of seller's information, wherein the seller's information includes volume-dependent prices for at least one good or service;
comparing the customer bid to the seller's information;
presenting a response to the customer.

2. The method of claim 1, wherein the bid comprises an identification of a good or service to be purchased, a quantity desired, and a price.

3. The method of claim 2, wherein the bid further comprises at least one seller-defined variable that affects the price.

4. The method of claim 1, wherein the seller's information comprises at least one good or service to be sold, and the volume-dependent prices comprise acceptable prices corresponding to various quantities of the goods and/or services to be sold.

5. The method of claim 4, wherein the seller's information further includes at least one seller-defined variable that affects the price.

6. The method of claim 4, further comprising comparing the customer bid to other customer bids and accepting a predetermined number of high bids.

7. The method of claim 4, wherein the comparison of the bid to the seller's information includes a determination of whether the price and quantity of the bid is equal to or greater than one of the acceptable prices and its corresponding quantity.

8. The method of claim 7, wherein if the determination is that the price and quantity of the bid is equal to or greater than one of the acceptable prices and its corresponding quantity, the bid is accepted.

9. The method of claim 7, wherein if the determination conveys that the price and quantity of the bid is less than one of the acceptable prices and its corresponding quantity, the bid is not accepted and the customer is presented with an invitation to submit a subsequent bid.

10. The method of claim 9, wherein the invitation is withdrawn if the customer does not submit the subsequent bid within a predetermined time period.

11. The method of claim 9, further comprising the steps of adding each bid and subsequent bid to a table; and comparing each subsequent bid to the table before the subsequent bid is compared to the database of seller's information, and determining whether the subsequent bid comprises a modification to a previous bid submitted by the same customer within a predetermined time.

12. The method of claim 11, wherein if the bid comprises a modification to a previous bid submitted by the same customer within a predetermined time, the bid is not accepted and the customer is presented with an invitation to submit a subsequent bid.

13. The method of claim 11, wherein if the bid does not comprise a modification to a previous bid submitted by the same customer within a predetermined time, the bid is compared to the seller's information and further processed to determine acceptability.

14. The method of claim 1, further comprising the steps of:
receiving logon information from a customer;
determining whether the logon information corresponds to a recognized customer.

15. The method of claim 14, wherein if the customer is not a recognized customer, the customer is invited to enter seller-defined information variables to become a recognized customer.

16. The method of claim 1, wherein the steps of receiving a bid from a customer and presenting a response to a customer are performed by a streaming media method.

17. A system for computer-implemented volume-dependent negotiation of the sale of goods and/or services, comprising:
a computing device capable of communicating via a network;
a processor;
a memory;
an interface means for enabling a customer to input data;

18. The system of claim 17, wherein the memory includes a database that includes seller's information which stores volume-dependent prices for at least one good or service.

19. The system of claim 18, wherein the database that includes seller's information further includes at least one customer-defined variable that affects the price.

20. The system of claim 18 wherein the memory stores computer program instructions that instruct the computer to perform steps comprising:
prompting the customer to input a bid;
accessing the database that includes seller's information;
comparing the customer bid to the database that includes seller's information;
presenting a response to the customer.

21. The system of claim 17, wherein the memory and the interface means are communicatively connected via a communications network.

22. The system of claim 20, wherein the database that includes seller's information further includes seller-defined variables that affect the price.

23. The system of claim 17, wherein the computing device is connected to another computing device which includes a database that includes seller's information which stores volume-dependent prices for at least one good or service.

24. The system of claim 17, further comprising another memory contained which is contained within the computing device and which includes a database that includes seller's information which stores volume-dependent prices for at least one good or service.

25. A system for performing volume-dependent negotiations for the purchase of at least one good and/or service by customers, comprising:
means for receiving customer input data relating to price and quantity of at least one good and/or service to be purchased;
means for storing a database of seller's information relating to price and quantity of at least one good and/or service to be purchased;
means for comparing the customer input data to the database of seller's information;
means for presenting a response to a customer depending upon the outcome of the comparison of the customer input data to the seller's information.
